(19) United States
(12) Patent Application Publication
(10) Pub. No.: US 2006/0182270 A1
(43) Pub. Date: Aug. 17, 2006

(54) Apparatus and method for communications

(76) Inventor: John Burns, Essex, MA (US)

Correspondence Address: James W. Wiegand;Law Office Of James Wiegand, Suite 700, 60 State Street, Boston, MA, 02109, US

(21) Appl. No.: 11/250,062

(22) Filed: Oct. 13, 2005

Related U.S. Application Data
(63) Continuation of application No. 10/912,604, filed on Aug. 5, 2004.

(51) Int. Cl. H04M 1/00

(52) U.S. Cl. 379/430

(57) ABSTRACT

A personal communications device is integrated with a hat. The hat provides support for the communications device and may also protect a user against the elements (e.g., rain, sun, snow). The hat may also be of any style (men's or women's), including, but not limited to; billed caps, such as baseball caps; brimmed caps, such as a fedora; and brimless hats, such as stocking or watch caps. The communications device may take the form of a two-way radio, cellular telephone, digital media player, or personal digital assistant, for example.

### CROSS-REFERENCE TO RELATED APPLICATIONS

This application is a continuation of U.S. patent application Ser. No. 10/912,604, entitled, “APPARATUS AND METHOD FOR COMMUNICATIONS,” which is hereby incorporated by reference in its entirety. The present application has the same inventor as, and claims benefit of the same filing date, Aug. 5, 2004, as this application.

### FIELD OF THE INVENTION

The invention relates to communications and, in particular, to a convenient housing and support for personal communications devices.

### BACKGROUND OF THE INVENTION

Personal communications devices find many applications and take many forms. Two-way radios are employed by coaches on the sidelines of a football game, by arborists, and by other workers trying to keep in touch with their compatriots. Cellular telephones are ubiquitous and, in some countries, are the default means of communications, taking precedence over landline telephones. The portable nature of such devices (that is, two way radios, cellular telephones, and personal music players) encourages users to multi-task with them; a pedestrian or driver may engage in a cellular telephone conversation while walking or driving, a coach may engage in a spirited conversation on the sidelines as he races towards a field official, or an arborist may talk to fellow workers on the ground as he trims branches high in a tree.

Attempts have been made to provide hands-free operation for communications devices. Many cellular telephone users employ headsets to speak as they walk along a sidewalk or drive in their cars. Headsets provide no protection from the elements (e.g., the rain and snow) Two-way radios are sometimes attached to hardhats, so that construction workers may communicate with one another while working. Hard hats, however, are extraordinarily cumbersome and uncomfortable, due to both their weight and their lack of breathability. By a lack of breathability, I mean that little or no fresh air can get to a wearer's head to help cool the wearer).

Current alternatives do not, however, provide a communications system that allows hands-free operation, provides protection from the elements, and due to its breathability, is comfortable.

An apparatus and method for the housing and support of personal communications devices that provides protection from the elements, is comfortable to the user, and complements a user's apparel would therefore be highly desirable.

### SUMMARY

In accordance with the principles of the present invention, a personal communications device is incorporated with a hat. The hat provides support for the communications device and may also protect a user against the elements (e.g., rain, sun, snow) while providing a fashionable complement to the user's wardrobe.

The hat may be made of any of a variety of lightweight, “breathable” materials, such as cloth, straw, or nylon mesh, for example. The hat may also be of any style (men's or women's), including, but not limited to; billed caps, such as baseball caps; brimmed caps, such as a fedora; and brimless hats, such as stocking or watch caps. The communications device may take the form of a two-way radio, a cellular telephone, or a personal music player, IPod™ for example. The personal communications device includes the elements of a headset (that is, a transceiver, a microphone, and one or more earphones) and, in a cellular telephone embodiment, may also include a handset for dialing, or a display. The communications device may also respond to oral commands.

In addition to offering protection from the elements and providing a fashionable accessory, an integrated communications hat in accordance with the principles of the present invention may provide advertising space for logos. In particular, a baseball style communications hat in accordance with the principles of the present invention may incorporate a logo, such as a Boston Red Sox™ logo, a New England Patriots™ logo, or, for a different market, a DeKalb™ seed corn logo.

In one aspect of the invention, earphones may be incorporated in the hat in a position proximate to a wearer's ears. The earphones may be housed within pockets in such locations or attached to flaps, sliders, pivots or other mechanisms that allow the earphones to be moved from a retracted position to a position directly over the wearer's ears. All manner of earphones, including every size from buds that are insertable into a wearer's ears to earphones that fully encompass a wearer's ears are contemplated within the scope of the invention.

In a cellular telephone embodiment of a communications hat in accordance with the principles of the present invention, a handset or keypad may be housed in the hat in a location that is convenient for dialing. For example, a handset may be housed in a pocket on the bottom side of a baseball-style hat's brim. Additionally, the hat may include a global positioning system (GPS) locator unit or a personal music player, either in conjunction with a cellular telephone, or as a stand-alone component.

In an illustrative embodiment, a hat incorporates a personal communications device by distributing the components of the personal communications device throughout the structure of the hat. The components (and corresponding interconnection means) of the personal communications device may be distributed using three-dimensional molded circuitry or flexible circuitry, for example. The components may, for example, be incorporated into the fabric of a hat by inserting components into pockets or sleeves distributed throughout the crown of the hat. The components may be inserted of and may be retained through readily-releasable means such as fasteners, including: buttons, hook and loop fasteners, tabs, or zippers, for example. Alternatively, the components and interconnection means may be permanently embedded within the hat by sewing them between layers in the crown of the hat, by forming them into a hatband using three-dimensional molded circuit technology, or by threading the components and interconnections through apertures in the crown and/or brim of the hat, for example.

In an illustrative embodiment, a hat brim in accordance with the principles of the present invention includes top and bottom molded layers. When pieced together the top and bottom layers create a three-dimensional brim or bill, with a cavity contained between the top and bottom layers. In this illustrative embodiment, the cavity contains electronics that constitute at least a portion of a personal communications device, such as a cellular telephone, a personal digital assistant, or a multimedia player, for example. In this illustrative embodiment, the molded bill of the hat (which may, for example, be the brim of a variety of hat types, including “baseball” style hat, fedora, or “cowboy” style, for example) thereby forms a structure, much like a molded plastic structure that houses conventional personal communications devices, such as cellular telephones, except that, in this illustrative example, the housing for the electronics also functions as a part of the hat which, for example, channels water away from the head and face of a wearer.

### BRIEF DESCRIPTION OF THE DRAWINGS

The above and further features, aspects, and advantages of the invention will be apparent to those skilled in the art from the following detailed description, taken together with the accompanying drawings in which:

FIGS. 1A and 1B are, respectively, partial sectional and bottom plan views of a personal communications-integrated hat in accordance with the principles of the present invention; and

FIG. 2 is a perspective view of a three dimensional molded circuit containing one or more components of a personal communications device in accordance with the principles of the present invention;

FIGS. 3A and 3B are, respectively, side and bottom exploded views of a three-dimensional molded embodiment of a personal communications device in accordance with the principles of the present invention; and

FIGS. 4A and 4B are, respectively, side and bottom exploded views of a three-dimensional molded embodiment of a personal communications device in accordance with the principles of the present invention.

### DETAILED DESCRIPTION

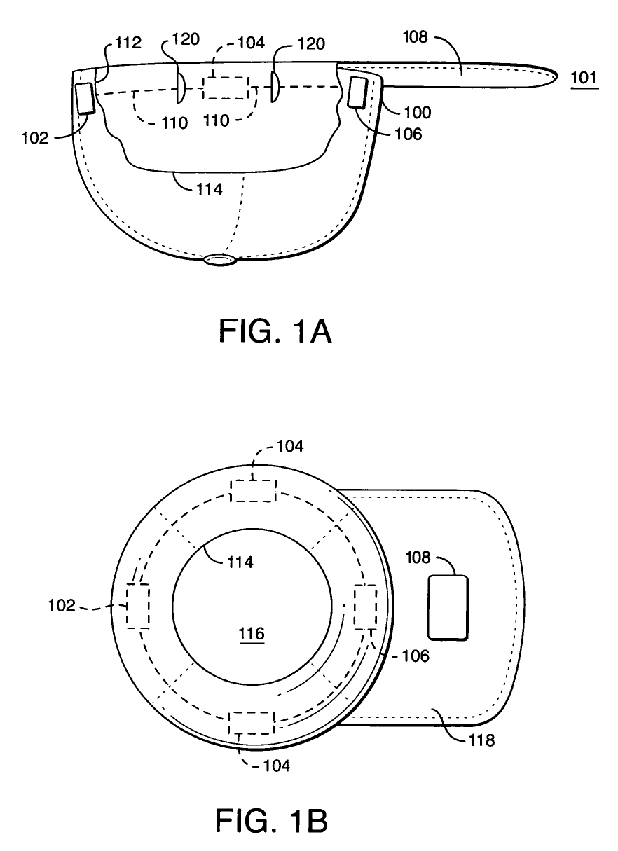

FIG. 1 is a partial sectional view of an illustrative embodiment of a communications device 101 in accordance with the principles of the present invention. In this illustrative embodiment a hat 100 incorporates a personal communications device by distributing the components of the personal communications device throughout the structure of the hat 100. Components in this illustrative embodiment include a power pack 102, one or more earpieces 104, a source 106, user interface 108 and interconnections 110.

The power pack 102 may be a battery pack that accommodates primary (single use) or secondary (rechargeable) batteries, for example. Because the power source is integrated into the hat 100 and is to be worn by a user, the power source's technology is preferably a high-energy-density type; one that adds minimal weight to the hat 100. In addition to more conventional primary “dry” cells, a fuel cell may be employed as a power source for a personal communications system in accordance with the principles of the present invention. Compact secondary batteries that may be employed in the power pack 102 include: Nickel Cadmium, Nickel-Metal Hydride, Lithium Ion, or Lithium Polymer type batteries. Lithium Polymer batteries, in addition to being compact, may be made in thin flat or shape-fitting forms that conform to the shape of the hat's crown, for example, and may, therefore, be more readily integrated into the hat 100.

The one or more earpieces 104 may take any of a number of suitable forms. The earpieces may employ electromagnetic drive elements or piezoelectric drive elements. Additionally, the earpieces, particularly those of the “bud” type that are inserted in ears for use (“bud” type earphones are discussed in more detail in the parent application of the present application. Such earphones are known and available from a variety of sources, for example, from Ultimate Ears, Inc, www.ultimateears.com), may employ sound isolation techniques to improve the quality of sound delivered to a user of the communications device 101. Pockets may be formed in the hat 100 for storage of bud type earphones at locations proximate to a user's ears, for example. Earpieces, or speakers, that employ piezoelectric drive elements (distributed mode actuators, for example) are typically much more efficient at converting the electrical energy from a source, such as the source 106, into acoustic energy than speakers employing electromagnetic drive elements. Speakers that employ piezoelectric drive elements are known and available, for example, from NXT Sound, www.nxtsound.com. Additionally, such earpieces are very light-weight and thin and are particularly suited to being permanently enclosed within the material of the hat at a location proximate a user's ears. Use of such earpieces allows fully-integrated inclusion of the earpieces within the fabric of the hat. For example, in an embodiment where the earpieces, are speakers, they may permanently sewn between layers of fabric, or situated inside a pocket 112 in the hat and secured by button, hook-and-loop, or other fastening means 114.

In illustrative embodiments, the source 106 may be a media player, for example. As a media player, the source 106 might support digital music player that supports one or more digital music formats, such as those compatible with an open source audio codec (e.g., OGG), free lossless audio codec (FLAC), active or advanced streaming fomat (ASF), Windows Media Audio (WMA), MPEG-1 layer 3 (MP3), or uncompressed audio files, such as WAV files. In a digital music player embodiment, the source may include digital storage, such as solid-state storage or disk storage, for example. Additionally, the source may include video, FM radio, voice and in-line recorders, photo and text file viewers. The source 106 may include a wireless port for hookup to other devices, such as digital cameras. In an embodiment in which the communications device includes a cellular telephone, the source 106 may include the elements of a cellular telephone handset, including, for example, the cellular telephone's receiver and transmitter. The source 106 may also provide personal digital assistant (PDA) functionality, such as that provided, for example, by Blackberry™ devices.

The bottom plan view of FIG. 1B provides a more comprehensive view of the distribution of a personal communications device's components throughout the hat 100. In this illustrative embodiment, components are integrated into both the crown 116 and brim 118 of the hat 100. The user interface 108 may include a display, miniature keypad, and membrane switches, for example, to provide input and output functionality appropriate for the various functionalities the source 106 may take on, as previously described.

The components, and corresponding interconnection means 110 of the personal communications device may be distributed throughout the hat 100 using three-dimensional molded circuitry or flexible circuitry, for example. The components may, for example, be incorporated into the fabric of a hat by inserting components into pockets or sleeves 112 distributed throughout the crown of the hat. The components may be inserted in and may be retained through readily-releasable means such as fasteners, including: buttons, hook and loop fasteners, tabs, or zippers, for example. Alternatively, the components and interconnection means 110 may be permanently embedded within the hat by sewing them between layers in the crown of the hat, by forming them into a hatband using three-dimensional molded circuit technology, or by threading the components and interconnections through apertures 120 in the crown and/or brim of the hat, for example.

In another aspect of the invention, one or more components of the communications device 101 may be located outside the hat 100, that is, not directly integrated with the hat 100, with the remaining components integrated with the hat 100. For example, the source 106 and/or the user interface 108 may be adapted for separate transport, in a user's pocket, or hand, for example. In such a configuration, the source 106 and/or user interface 108 may communicate with the components integrated with the hat, such as, the earpieces 104, or a microphone, for example, through wireless connections, such as a short-range radio frequency (RF) link. The short-range radio frequency link may, for example, conform to the standards propounded by the Bluetooth™ Special Interest Group.

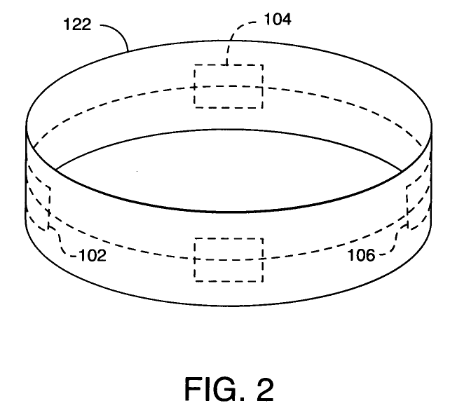

The perspective view of FIG. 2 provides an illustration of a three-dimensional molded circuit 122 integrating at least some of the components of a personal communications device in accordance with the principles of the present invention. In this illustrative embodiment, the three-dimensional molded circuit has been formed in a shape that would allow its ready inclusion in the crown of a hat, either within a pocket 112 of the hat crown 116, or as a hatband, for example. Three-dimensional molded circuits are known and available from a variety of manufacturers. For example, Matrix, Inc. employs an insert molding process that places parts (e.g., components) into empty mold cavities so that injected plastic traps the parts to form combinations. The injection molding process entails pumping molten thermoplastic into multiple-cavity molds cooling it to a solid, and ejecting the finished parts. PCK Kollmorgan offers molded circuit board technologies. Other technologies available for the production of three dimensional circuits that may be employed by a personal communications device in accordance with the principles of the present invention include: additive plate and etch (APE), Amphenol Dry Additive Process (ADAP), molded interconnection packages (Mint-PAC), Allen Bradley provides a flexible circuit insert-mold process, Capsonic a process for insert molding metal conductors into plastics, and a Konec™ polymer thick film process from Elite Circuits.

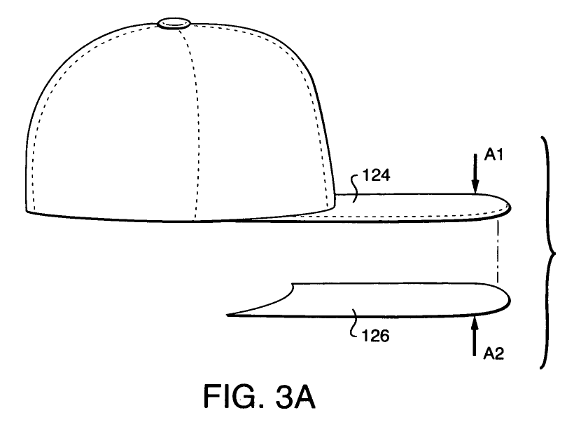

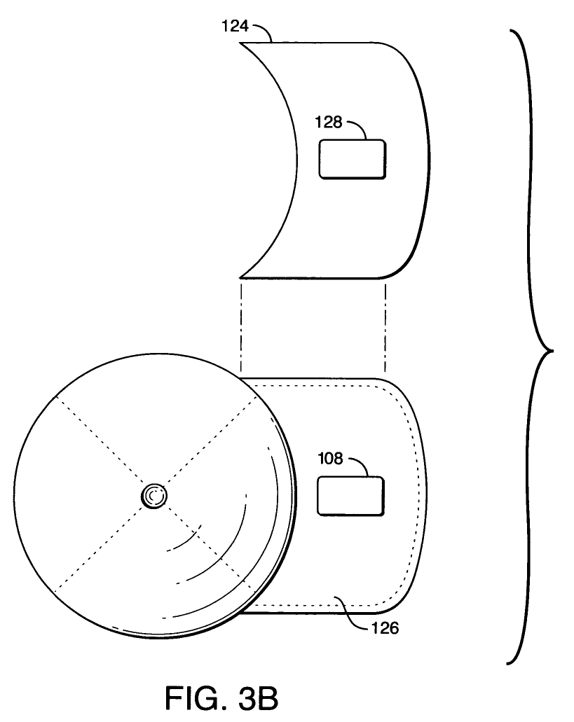

FIGS. 3A and 3B are, respectively, exploded landscape and exploded bottom plan views of a baseball style hat that embodies a three dimensional molded circuit personal communications device in accordance with the principles of the present invention. In this illustrative embodiment the hat's bill includes top 124 and bottom 126 molded pieces that, when joined (for example through compression fit or fasteners) in the direction indicated by the arrows A1 and A2 forms a bill that encompasses one or more components of the personal communications device. In this illustrative embodiment, a user interface 108 is formed on the top 124 molded piece of the brim and includes an aperture 128 that provides access to the user interface 108 when the top 124 and bottom 126 are engaged for use.

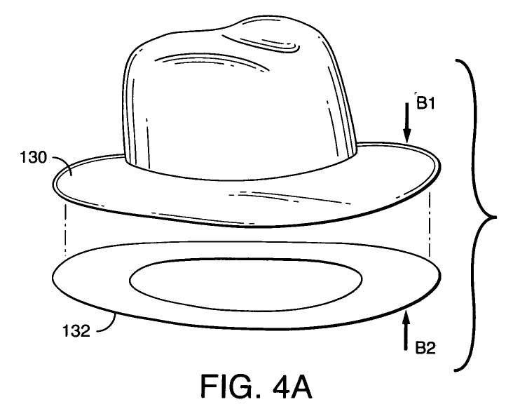

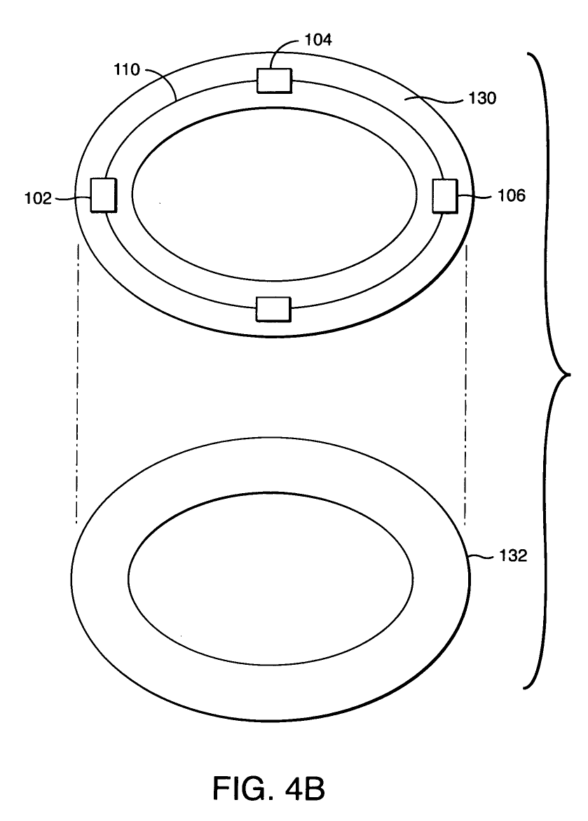

Similarly, FIGS. 4A and 4B are, respectively, exploded landscape and exploded bottom plan views of a full-brimmed hat (e.g., fedora- or cowboy-style) hat that embodies a three-dimensional molded circuit personal communications device in accordance with the principles of the present invention. In this illustrative embodiment the hat's brim includes top 130 and bottom 132 molded pieces that, when joined in the direction indicated by the arrows B1 and B2 forms a bill that encompasses one or more components of the personal communications device. In this illustrative embodiment, components such as earpieces 104, a source 106, and a power pack 102, along with interconnecting circuitry 110 may be formed on the top 130 molded piece of the brim and the top 130 and bottom 132 may be engaged for use, for example, using compression fit or fasteners.

The foregoing description of specific embodiments of the invention has been presented for the purposes of illustration and description. It is not intended to be exhaustive or to limit the invention to the precise forms disclosed, and many modifications and variations are possible in light of the above teachings. For example, the locations of various components in the illustrative embodiment(s) are somewhat arbitrary and may be modified significantly while keeping within the scope of the invention. The embodiments were chosen and described to best explain the principles of the invention and its practical application, and to thereby enable others skilled in the art to best utilize the invention. It is intended that the scope of the invention be limited only by the claims appended hereto.

What is claimed is:

1. An apparatus comprising:
a hat; and
a personal communications device incorporated into the hat, the personal communications device including a plurality of components, wherein at least one component of the personal communications device is enclosed within the structure of the hat.

2. The apparatus of claim 1 wherein the hat comprises a crown and a brim and at least one component of the personal communications device is enclosed within the structure of the brim.

3. The apparatus of claim 1 wherein the hat comprises a crown and a brim and at least one component of the personal communications device is enclosed within the structure of the crown.

4. The apparatus of claim 1 wherein the hat comprises a crown and a brim, the personal communications device includes at least one speaker and the at least one speaker is enclosed within the structure of the crown of the hat.

5. The apparatus of claim 4 wherein the at least one speaker is a piezoelectric speaker.

6. The apparatus of claim 1 wherein the personal communications device includes technology that permits at least one component of the personal communications device to communicate wirelessly with at least one other component of the personal communications device.

7. The apparatus of claim 6 wherein the personal communications device comprises at least one speaker that includes technology which permits the speaker to communicate wirelessly with a source that may be located external to the hat.

8. An apparatus comprising:
a hat; and
a personal communications device incorporated into the hat, the personal communications device including a plurality of components, including at least one speaker, wherein a plurality of the personal communications device's components are enclosed within the structure of the hat, and those components that are so enclosed are distributed throughout the hat in a manner that positions the at least one speaker in close proximity to a wearer's ear.

9. The apparatus of claim 8 wherein the components are distributed throughout the hat in a manner that substantially balances the weight of the components.

10. The apparatus of claim 8 wherein the components and interconnections among the components are formed in a molded structure that is integrated into a pocket within the structure of the hat.

11. The apparatus of claim 10 wherein the molded structure is integrated into the pocket with readily removable fastening means.

12. The apparatus of claim 11 wherein the fastening means is a hook and loop fastening means.

13. The apparatus of claim 10 wherein the molded structure is integrated into the pocket with permanent fastening means.

14. The apparatus of claim 13 wherein the molded structure is sewn into the pocket.

15. The apparatus of claim 8 wherein the communications device is a cellular telephone.

16. The apparatus of claim 8 wherein the communications device is a two-way radio.

17. The apparatus of claim 8 wherein the communications device is a digital media player.
